(19) United States
(12) Patent Application Publication
(10) Pub. No.: US 2004/0000123 A1
(43) Pub. Date: Jan. 1, 2004

(54) Ultra bright materials and methods

(76) Inventor: Donald E. Weder, Highland, IL (US)

Correspondence Address: DUNLAP, CODDING & ROGERS P.C., PO BOX 16370, OKLAHOMA CITY, OK, 73113, US

(21) Appl. No.: 10/606,561

(22) Filed: Jun. 26, 2003

Related U.S. Application Data
(63) Continuation of application No. 10/038,925, filed on Jan. 4, 2002, now abandoned.
Application No. 10/038,925 is a continuation of application No. 09/459,962, filed on Dec. 13, 1999, now abandoned.
Application No. 09/459,962 is a continuation of application No. 09/103,050, filed on Jun. 22, 1998, now abandoned.

(51) Int. Cl. B65B 11/00; B32B 15/00

(52) U.S. Cl. 53/397; 53/416; 428/607; 428/621

(57) ABSTRACT

An ultra bright material formed from a metallic foil connected to a metallized film, used as a floral wrapper, a floral sleeve wrapper, a pot wrapper, a preformed flower pot cover, a pot sleeve having a detachable portion which forms a decorative cover, and glitter, confetti, tinsel, and the like. Methods of making and using an ultra bright film in a variety of applications.

### CROSS-REFERENCE TO RELATED APPLICATIONS

This application is a continuation of U.S. Ser. No. 10/038,925, filed Jan. 4, 2002, entitled “ULTRA BRIGHT MATERIALS AND METHODS;” which is a continuation of U.S. Ser. No. 09/459,962, filed Dec. 13, 1999, entitled “ULTRA BRIGHT MATERIAL AND METHODS,” now abandoned; which is a continuation of U.S. Ser. No. 09/103,050, filed Jun. 22, 1998, entitled “ULTRA BRIGHT MATERIAL AND METHODS,” now abandoned.

### STATEMENT REGARDING FEDERALLY SPONSORED RESEARCH OR DEVELOPMENT

Not applicable.

### BACKGROUND OF THE INVENTION

1. Field of the Invention

This invention relates to ultra bright sheets of material used for floral packaging, and particularly, to ultra bright sheets of material used as floral wrappers and sleeves, used to wrap flower pots or containers, and used as preformed flower pot covers, and the methods of making and using same.

2. Description of Related Art Including Information Disclosed Under 37 CFR § 1.97 and 37 CFR § 1.98

Metallic foil is used to some extent in floral packaging and gift wrap. Metallic foil has as its primary desirable characteristic a bright, shiny, eye-catching, metallic and light reflecting effects, as well as dead-fold characteristics.

Metallic foils such as, but not by way of limitation, aluminum foil, are well known to be reflective within a particular range of reflectivity for that metal. However, metallic foils are highly susceptible to tearing and creasing. Further, metallic foils have significant dead-fold characteristics such that the metallic foil holds whatever shape surrounding forces subject it to, including a crumpled shape. In other words, metallic foils have detrimental attributes that frequently prevents the use of a metallic foil alone in floral packaging, because of the likelihood of inadvertent crushing or being formed into a shape which is undesirable during shipping and/or handling.

Plastic film has also been utilized in floral packaging and gift wrap. Such plastic films do not have dead-fold characteristics, as does metallic foil. In fact, most plastic film used in floral packaging will not, on their own, hold a shape, and are deemed non-shape sustaining. The plastic film utilized in floral packaging is frequently substantially non-tearable. Examples of such plastic films are found in U.S. Pat. No. 5,111,638, entitled “Method For Wrapping An Object With A Material Having Pressure Sensitive Adhesive Thereon, issued to D. Weder, May 12, 1992; U.S. Pat. No. 5,111,637 entitled “Method For Wrapping A Floral Grouping” issued to Weder et al., on May 12, 1992; and U.S. Pat. No. 5,181,364, entitled “Wrapping A Floral Grouping With Sheets Having Adhesive Or Cohesive Applied Thereto”, issued to Weder et al. Jan. 26, 1993.

Metallic foil and plastic film have been laminated to form a separate packaging material. Such a combination, however, reduces the reflectiveness of the metallic film. One example of such a laminated foil/film is disclosed in U.S. Pat. No. 4,297,811 entitled “Laminated Printed Foil Flower Pot Wrap With Multicolor Appearance, issued to Weder on Nov. 3, 1981.

Some plastic film is metallized, and provides a very bright, shining, reflective appearance. Examples of metallized films are disclosed in U.S. Pat. No. 5,631,066, entitled “Process For Making Metalized Films and Films Produced Therefrom”, issued to O'Brien et al. on May 20, 1997; U.S. Pat. No. 5,753,363, entitled, “Metallized Film Structure”, issued to Bader et al. on May 19, 1997; and U.S. Pat. No. 5,725,962, entitled, “Oriented HDPE Films With Metallized Skin Layer”, issued to Bader et al. on Mar. 10, 1998. Such metallized films have a very thin layer of metal which creates this bright effect. This metallic layer is quite thin, and it is often layered so thinly upon the film such that one can actually see through the film, in spite of the metallized layer. This thin metallized layer easily rubs off of the film as well, creating an unattractive appearance. And, the metallized film is not shape sustaining. That is, the metallized film has no dead-fold characteristics.

The present invention provides a film having a much brighter finish than either a metallic film, such as, but not by way of limitation, aluminum foil, or a plastic metallized film. The present invention contemplates laminating a reflective material such as, but not by way of limitation, a plastic metallized film to another reflective material such as, but not by way of limitation, a metal foil, such as, for example, aluminum foil. When a metal foil is laminated to a metallized film, the effect is a cumulative shininess or brightness of the reflected light, greatly magnified due to an optical synergistic effect incorporating the principle of specular reflection. The laminated metallic materials thus become ultra bright.

That is, the extremely reflective properties of the brightest, most reflective side of a metal foil, such as, but not by way of limitation, aluminum foil, is laminated adjacent a plastic metallized film. The brightness of the aluminum foil accentuates the brightness of the metallized film, such that the thin layer which creates the metallic appearance of the plastic film is substantially brightened and sustained by such lamination. Further the combined film has a brightness which will not rub off, and which is not dissipated visually by being seen through. Further, such a combination reduces the dead-fold characteristics of the metal foil, as well as the easy tearability of the foil. The combination also provides a foil/film material having shape sustaining characteristics, but without having extreme dead-fold characteristics, such as crumpling or inadvertent shapes formed during shipping and/or handling.

The present invention contemplates a combination which has sufficient shape sustaining qualities that the combination may be formed into a predetermined shape of an article. The article may then be flattened and unflattened, and when unflattened, the article will easily assume the predetermined shape. This characteristic is unlike that of foil.

It is an objective of this invention to provide an ultra bright material which has considerable light reflective qualities on each side of the material. It is a further goal of this invention to provide a material having shape-sustaining qualities without extreme dead-fold characteristics. It is a further objective of this invention to provide a material having a sufficient thickness, yet flexibility, that the metallic layer cannot be seen through, or easily removed via purposeful or inadvertent rubbing. It is still a further goal of this invention to provide a material having sufficient shape sustaining qualities that the material may be formed into a predetermined shape of an article, then flattened and unflattened, with the article easily reassuming the predetermined shape when unflattened.

### BRIEF SUMMARY OF THE INVENTION

An ultra bright material is disclosed. The ultra bright material comprises a metal foil and a metallized film. The metal foil and metallized film are connected together to form an ultra bright material. The ultra bright material has a first surface and a second surface, the first surface and the second surface each having a reflective shininess. The ultra bright material has at least some shape-sustaining characteristics. The ultra bright material has a reflective shininess that cannot be seen through, and no portion of the reflective shininess is easily removable.

The ultra bright material may comprise a bonding material. The bonding material may comprise an adhesive bonding material, or, alteratively, a cohesive bonding material. The ultra bright material may also further comprises materials selected from the group consisting of paper, cellophane, foil, plastic film, metallized film, fabric, fiber, burlap, and any combination thereof. The ultra bright material may further comprise characteristics selected from the group consisting of decorations, colorings, coatings, embossings, flockings, metallic finishes, pearlescent finishes, translucent finishes, transparent finishes, iridescent finishes, neon finishes, holographic finishes, holographic designs, opaque finishes, clear finishes, and any combination thereof. The ultra bright material is often constructed from a sheet of material having a thickness in a range of about 0.1 mils to about 10 mils. Alternatively, the ultra bright material is constructed from a sheet of material having a thickness in a range of about 0.4 mils to about 2.0 mils. The ultra bright material may be cut into elongated portions, such as, for example, decorative grass, tinsel, confetti, and the like. The ultra bright material may also be cut into small pieces, such as, for example, glitter, labels, and the like. It will be understood that these additional characteristics may be displayed by any apparatus, assembly and/or method disclosed and/or claimed herein.

An assembly is also disclosed. The assembly comprises an item having an outer periphery, and an ultra bright material. The ultra bright material comprises a metal foil and a metallized film. The metal foil and metallized film are connected together to form the ultra bright material. The ultra bright material has a first surface and a second surface, the first surface and the second surface each having a reflective shininess. The ultra bright material has at least some shape-sustaining characteristics. The ultra bright material has a reflective shininess that cannot be seen through, and no portion of the reflective shininess is substantially easily removable. The item is covered by the ultra bright material, the ultra bright material forming a wrapping about the item and surrounding and encompassing at least a portion of the outer periphery of the item.

The item often comprises a floral grouping, and the ultra bright material forms a floral wrapper about the floral grouping.

When the item comprises a floral grouping, the ultra bright material may also form a sleeve, which forms a floral sleeve wrapper about the floral grouping. Alternatively, the item may comprise a pot, and the ultra bright material forms a pot wrapper about the pot. In another alternative, when the item comprises a pot, the ultra bright material may form a preformed flower pot cover to cover the pot. In yet another alternative, when the item comprises a pot, and the ultra bright material may form a pot sleeve about the pot, a portion of the pot sleeve being removable, leaving a decorative cover about the pot.

A method of forming an ultra bright material is also disclosed. A metal foil is provided, as is a metallized film. The metal foil and metallized film are connected together to form an ultra bright material. The ultra bright material has a first surface and a second surface, the first surface and the second surface each having a reflective shininess. The ultra bright material has at least some shape-sustaining characteristics. The ultra bright material has a reflective shininess that cannot be seen through, and no portion of the reflective shininess is easily removable.

A method for providing a decorative assembly is disclosed. In the method, an item having an outer periphery and an ultra bright material are each provided. The ultra bright material comprises a metal foil and a metallized film which are connected together to form the ultra bright material. The ultra bright material has a first surface and a second surface, the first surface and the second surface each having a reflective shininess. The ultra bright material has at least some shape-sustaining characteristics. The ultra bright material has a reflective shininess that cannot be seen through, and no portion of the reflective shininess is easily removable. At least a portion of the ultra bright material is positioned about the outer periphery of the item. The portion of the ultra bright material disposed about the outer periphery of the item forms a wrapping about the item.

In the method described above, the item often comprises a floral grouping, and the ultra bright material forms a floral wrapper about the floral grouping. When the item comprises a floral grouping, the ultra bright material may also form a sleeve, which forms a floral sleeve wrapper about the floral grouping. Alternatively, the item may comprise a pot, and the ultra bright material forms a pot wrapper about the pot. In another alternative, when the item comprises a pot, the ultra bright material may form a preformed flower pot cover to cover the pot. In yet another alternative, when the item comprises a pot, and the ultra bright material may form a pot sleeve about the pot, a portion of the pot sleeve being removable, leaving a decorative cover about the pot.

### BRIEF DESCRIPTION OF THE SEVERAL VIEWS OF THE DRAWINGS

FIG. 1 is a perspective view of a first sheet of material formed from metallic foil constructed in accordance with the present invention, a corner lifted for illustration purposes only.

FIG. 2 is a perspective view of a second sheet of material formed from a metallized film constructed in accordance with the present invention, a corner lifted for illustration purposes only.

FIG. 3 is a perspective view of the ultra bright material constructed in accordance with the present invention, formed from the first sheet of material of FIG. 1 and the second sheet of material of FIG. 2 laminated together to form the ultra bright material, constructed in accordance with the present invention, one corner lifted for illustration purposes only.

FIG. 4 is a side plan view of the ultra bright material of FIG. 3, showing the first sheet of material connected to the second sheet of material.

FIG. 5 is a perspective view of a pad of ultra bright sheets of material constructed in accordance with the present invention, showing the top sheet lifted, exposing the second sheet.

FIG. 6 is a perspective view of a plurality of ultra bright sheets of material constructed in accordance with the present invention forming a continuous roll of sheets of material, the sheets of material separated by perforations, and the roll partially unrolled to reveal a single sheet of material attached thereto.

FIG. 7 is a perspective view showing a roll of ultra bright sheets of material wherein the roll is disposed in a dispenser for separating the roll into separate sheets of ultra bright material and dispensing the separate sheets from the roll.

FIG. 8 is a perspective view of a floral grouping disposed on a sheet of ultra bright material.

FIG. 9 is a perspective view of the floral grouping of FIG. 13 being wrapped in one method of wrapping.

FIG. 10 is a perspective view of the floral grouping wrapped in a conical fashion.

FIG. 11 is a perspective view of another method of using an ultra bright sheet of material to wrap a floral grouping in a cylindrical fashion.

FIG. 12 is a perspective view of another embodiment of the ultra bright sheet of material of the present invention, a pot disposed upon the sheet.

FIG. 13 is a perspective view of the ultra bright sheet of material of FIG. 12, but showing the ultra bright sheet of material partially wrapped about the flower pot.

FIG. 14 is a perspective view of the ultra bright sheet of material of FIGS. 12-13, showing the ultra bright sheet of material wrapped about the flower pot, forming a pot wrapping.

FIG. 15 is a perspective view of a preformed decorative pot cover formed from an ultra bright sheet of material.

FIG. 16 is a perspective view of a pot having a floral grouping therein and the preformed decorative pot cover of FIG. 15, but showing the pot disposed into the preformed decorative pot cover.

FIG. 17 is a perspective view of another embodiment of the present invention, showing a flattened wrapper comprising a flattened sleeve for wrapping a floral grouping, the sleeve constructed from the ultra bright sheet of material.

FIG. 18 is a perspective view of another embodiment of the wrapper of FIG. 17, but showing the wrapper held in an opened position for receiving a floral grouping.

FIG. 19 is a perspective view of the wrapper of FIG. 18 but showing the floral grouping disposed inside of the wrapper with the bloom portion near the first end and the stem portion extending from the second end.

FIG. 20 is a perspective view of the wrapper of FIGS. 17-19 but showing the wrapper crimped about the stem portion of the floral grouping, the crimped portion forming overlapping folds.

FIG. 21 is a perspective view of another embodiment of the present invention, showing a wrapper comprising a pot sleeve for covering a flower pot and a floral grouping contained therein, the wrapper having an upper portion having vertical perforations torn at the upper portion of the sleeve for illustration purposes only, the wrapper also having non-linear circumferential perforations partially torn for illustration purposes only, the wrapper having a lower portion capable of forming a decorative cover when the upper portion is torn completely away, a decorative edge formed on the upper end of the lower portion of the wrapper.

FIG. 22 is a perspective view of the wrapper of FIG. 21, but showing the upper portion torn away, the lower portion forming a decorative cover having a non-linear decorative edge.

FIG. 23 is a perspective view of another embodiment of the present invention, showing a wrapper comprising a pot sleeve for covering a flower pot and a floral grouping contained therein, the wrapper having an upper portion having vertical perforations torn at the upper portion of the sleeve for illustration purposes only, the wrapper also having non-linear circumferential perforations partially torn for illustration purposes only, the wrapper having a lower portion having a skirt which is formed therewith, the wrapper forming a decorative cover when the upper portion is torn completely away, the skirt extending a distance from the upper end of the lower portion of the pot sleeve.

FIG. 24 is a perspective view of the wrapper of FIG. 23, but showing the upper portion torn away, the lower portion forming a decorative cover having a skirt extending a distance therefrom.

FIG. 25 is a perspective view of a roll of ultra bright material constructed in accordance with the present invention showing a plurality of knife edges being actuated by an actuator to cut at least a portion of the roll of metallic reflecting effect material into elongated strips of ultra bright material.

FIG. 26 is a perspective view of the roll of ultra bright material of FIG. 25, but showing the plurality of knife edges being actuated in a second direction, to cut the elongated strips into small pieces of ultra bright material.

### DETAILED DESCRIPTION OF THE INVENTION

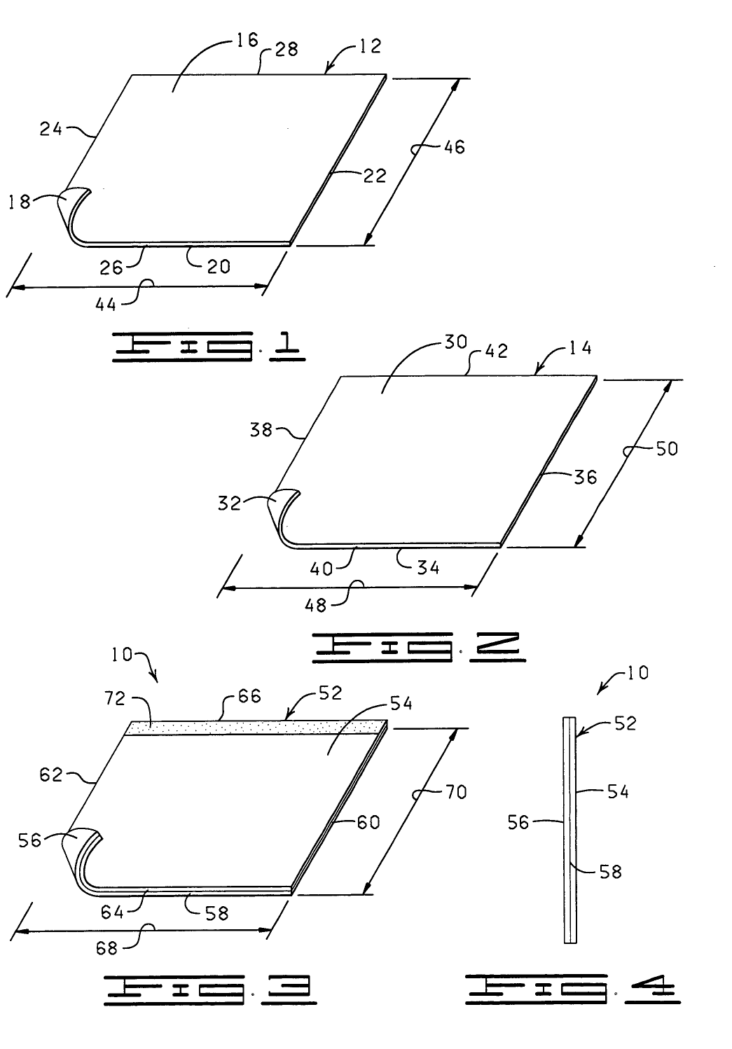

### The Embodiments and Methods of FIGS. 1-4

Referring to FIGS. 1-4, designated generally by the reference numeral 10 is an ultra bright material. The ultra bright material 10 is formed from a first sheet of material 12 and a second sheet of material 14.

The term “ultra bright” as used herein means a material having a much brighter finish than either a metallic film alone, such as, but not by way of limitation, aluminum foil, or a plastic metallized film alone. The reflective qualities of, for example, but not by way of limitation, a metal foil and a plastic metallized film, when connected together, form a cumulative shininess or brightness of reflected light, greatly magnified due to an optical synergistic effect incorporating the principle of specular reflection. The laminated metallic materials thus become “ultra bright.”

That is, the extremely reflective properties of the brightest, most reflective side of a metallic film, such as, but not by way of limitation, aluminum foil, is connected adjacent a metallized film. The brightness of the foil accentuates the brightness of the metallized film, such that the thin layer which creates the metallic appearance of the plastic film is substantially brightened by such lamination. Further, the combination film has brightness which will not rub off, and is not dissipated visually via the thinness of the metallized film, which often can be seen through.

This combination of materials also results in a reduction of the dead-fold characteristics of the metal foil, as well as the easy tearability of the foil. The combination of materials also provides a material having some shape-sustaining characteristics, which the metallized film would not have, without having extreme dead-fold characteristics of foil alone.

Turning to FIG. 1, the first sheet of material 12 has an upper surface 16, a lower surface 18, and an outer periphery 20. As shown in FIG. 1, the outer periphery 20 further comprises a first side 22, a second side 24, a third side 26 and a fourth side 28. It will be appreciated that the sheet of material 12 may comprise a variety of shapes, and sides.

Turning to the characteristics of the first sheet of material 12, the first sheet of material 12 has a thickness in a range from about 0.1 mils to about 10 mils. Preferably, the first sheet of material has a thickness in a range from about 0.4 mils to about 2.0 mils. The first sheet of material 12 is constructed of a material which is characterized by substantial reflective qualities and by substantial shape-sustaining qualities, the first sheet of material 12 having substantial dead-fold characteristics.

The first sheet of material 12 may be any shape or combination of shapes, and a rectangular shape is shown in FIG. 1 only by way of example. The first sheet of material 12 for example only may be square, rectangular, circular or any other geometric, non-geometric, asymmetric or fanciful shape, such as, by way of example only, heart shaped, or any combination of geometric and non-geometric shapes, as shown in FIG. 1.

The first sheet of material 12 may be constructed of a single layer of material or a plurality of layers of the same or different types of materials. The layers of material comprising the first sheet of material 12 may be laminated together or connected together by any method known in the art.

In one embodiment, the first sheet of material 12 is a light reflecting material constructed at least partially from a metal foil, or from any suitable metal and/or metallic material that is capable of reflecting light outward from the metallic material and permitting the metallic effect of the metallic material to be substantially maintained when the metallic material is viewed in the presence of any light generating sources. Such a foil may be constructed from, for example, but not by way of limitation, aluminum foil. Such foils are known in the art and commercially available. The metallic foil may also comprise paper, (the term “paper” as used herein means treated or untreated paper, corrugated paper or cardboard or any other form of paper material), cellophane, foil, plastic film, fabric (woven or nonwoven or synthetic or natural), and/or any combination thereof.

Turning to the characteristics of the second sheet of material 14, illustrated in FIG. 2 is the second sheet of material 14. The second sheet of material 14 has an upper surface 30, a lower surface 32 and an outer periphery 34. As shown in FIG. 2, the outer periphery 34 further comprises a first side 36, a second side 38, a third side 40, and a fourth side 42. The second sheet of material 14 is constructed a least partially from a plastic metallized film. The second sheet of material 14 is a light reflecting material and the light reflecting metallized film, laminated or connected to a metal foil, permits the light reflecting qualities of the second sheet of material 14 to be substantially amplified when the first sheet of material 12 is connected to the second sheet of material 14.

Metallized articles and the methods of making such articles are disclosed in U.S. Pat. No. 5,631,066, entitled “Process For Making Metalized Films and Films Produced Therefrom”, issued to O'Brien et al. on May 20, 1997; U.S. Pat. No. 5,753,363, entitled, “Metallized Film Structure”, issued to Bader et al. on May 19, 1997; and U.S. Pat. No. 5,725,962, entitled, “Oriented HDPE Films With Metallized Skin Layer”, issued to Bader et al. on Mar. 10, 1998, all of which are hereby incorporated by reference herein. The second sheet of material 14 has a thickness in a range from about 0.1 mils to about 10 mils. The second sheet of material 14 has a thickness preferably in a range of between about 0.4 mil and about 2.0 mils. The second sheet of material 14 is flexible, and is characterized by substantial reflective qualities but has no substantial shape-sustaining qualities.

The second sheet of material 14 may be any shape or combination of shapes, and a rectangular shape is shown in FIG. 2 only by way of example. The second sheet of material 14 for example only may be square, rectangular, circular or any other geometric, non-geometric, asymmetric or fanciful shape, such as, by way of example only, heart shaped, or any combination of geometric and non-geometric shapes.

The second sheet of material 14 may be constructed of a single layer of material or a plurality of layers of the same or different types of materials. The layers of material comprising the second sheet of material 14 may be laminated together or connected together by any method known in the art.

In one embodiment, the second sheet of material 14 is a light reflecting material constructed at least partially from a metallized film, such a film capable of reflecting light outward from the metallized surface of the film and permitting the reflective effects of the metallized film to be substantially maintained when the metallized film is viewed in the presence of any light generating sources. Such a metallized film is available, in a variety of thicknesses, from AMTOPP Corporation, Livingston, N.J. Metallized film is available from other commercial vendors as well. Further, it will be understood that the metallized film may also comprise paper, (the term “paper” as used herein means treated or untreated paper, corrugated paper or cardboard or any other form of paper material), cellophane, foil, fabric (woven or nonwoven or synthetic or natural), plastic film, or any combination thereof.

The term “plastic film” as used herein means a thermoplastic resinous material, such as, but not by way of limitation, a man-made polymer such as polypropylene or polyethylene. The term “plastic film” as used herein also means a naturally occurring polymer such as cellophane. A plastic film, as contemplated and described in detail herein, is relatively strong and not as subject to tearing (substantially non-tearable), as might be the case with paper or foil.

It will be understood that both the first sheet of material 12 and the second sheet of material 14 must be capable of being wrapped about a flower pot or floral grouping, or formed into a sleeve for containing a flower pot or floral grouping, or formed into a preformed flower pot cover, or used as a shredded decorative material, such as, but not by way of limitation, confetti, decorative grass, tinsel, glitter, flakes, and the like. Further, both the first sheet of material 12 and the second sheet of material 14 must also be suitable for making small die-cut items, such as decals, labels, stickers, stars, and the like.

The first sheet of material 12 has a length 44 extending between the first and second sides 22 and 24, respectively, of the first sheet of material 12. The first sheet of material 12 also has a width 46 extending between the third and fourth sides 26 and 28, respectively, of the first sheet of material 12.

The second sheet of material 14 has a length 48 extending between the first and second sides 36 and 38, respectively, of the second sheet of material 14. The second sheet of material 14 has a width 50 extending between the third and fourth sides 40 and 42, respectively, of the second sheet of material 14.

The first and/or second sheets of material 12 and 14 each may be constructed of a single layer of material or a plurality of the same or different types of materials. One or more sheets of material may be laminated or bonded together, completely or partially, by any method known in the art. When multiple sheets of material are used, the sheets of material need not be uniform in size or shape. That is, one sheet may extend beyond at least a portion of the outer periphery of another sheet of material.

The first and/or second sheets of material 12 and 14 may consist of designs or decorative patterns which are printed, etched, and/or embossed thereon using inks or other printing materials. An example of an ink which may be applied to the surface of the first and/or second sheets of material 12 and 14 is described in U.S. Pat. No. 5,147,706 entitled “Water Based Ink On Foil And/Or synthetic organic polymer” issued to Kingman on Sep. 15, 1992 and which is hereby incorporated herein by reference.

In addition, the first and second sheets of material 12 and 14 may have various colorings, coatings, embossings, flocking and/or metallic finishes, or other decorative surface ornamentation applied separately or simultaneously or may be characterized totally or partially by metallic or reflective or the like, qualities. Each of the above-named characteristics may occur alone or in combination and may be applied to the upper and/or lower surface of the first and second sheets of material 12 and 14. Moreover, each surface of the first and second sheets of material 12 and 14 may vary in the combination of such characteristics. The first and second sheets of material 12 and 14 may be opaque, translucent, or tinted transparent.

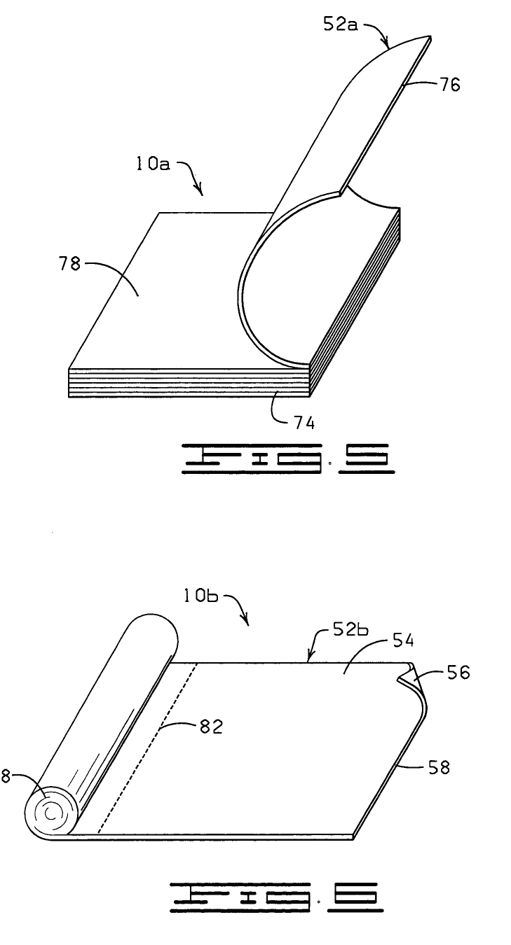

In an operation to form the ultra bright material 10, the second sheet of material 14 is placed adjacent the first sheet of material 12 as shown in FIG. 3. In this position, the lower surface 18 of the first sheet of material 12 is disposed adjacent the upper surface 30 of the second sheet of material 14, and the first and second sheets of material 12 and 14, respectively, are connected together via any means and/or method known in the art, or shown and/or described herein. It will be appreciated that a bonding material may be disposed on one or more surfaces of the first and/or second sheets of material 12 and 14 to create the connection between the first and second sheets of material 12 and 14.

It will be understood that the length 44 and the width 46 of the first sheet of material 12 is about equal to the length 48 and the width 50 of the second sheet of material 14 so that, when the first and the second sheets of material 12 and 14 are disposed adjacent each other, the outer periphery 20 of the first sheet of material 12 is aligned with the outer periphery 34 of the second sheet of material 14. That is, the first side 22, the second side 24, the third side 26, and the fourth side 28, respectively, of the first sheet of material 12 is generally in alignment with the respective first side 36, the second side 38, the third side 40 and the fourth side 42 of the second sheet of material 14. It should be noted, therefore, that the first and the second sheets of material 12 and 14 each have virtually identical lengths 44 and 48, respectively, and virtually identical widths 46 and 50, respectively, as well. When at least the first sheet of material 12 and the second sheet of material 14 are laminated together via bonding material or any means or method shown and/or described herein or known in the art, the ultra bright material 10 illustrated in FIG. 3 is formed. It will be appreciated that the ultra bright material 10 may form a sheet of material 52, pads of material, and/or rolls of material, the latter two being described in detail below.

Referring to FIGS. 3-4, the ultra bright material 10 comprises an ultra bright sheet of material 52 which has an upper surface 54, a lower surface 56 and an outer periphery 58. The outer periphery 58, as shown in FIG. 3, has a first side 60, a second side 62, a third side 64, and a fourth side 66. It will be understood, however, that the ultra bright sheet of material 52 may comprise a variety of shapes, and sides. The ultra bright sheet of material 52 also has a length 68 extending between the first and second sides 60 and 62. The ultra bright sheet of material 52 also has a width 70 extending between the third and fourth sides 64 and 66.

A bonding material 72, as shown in FIG. 3, may be disposed on at least a portion of the upper surface 54 of the ultra bright sheet of material 52, or alternatively, on the lower surface 56 of the ultra bright sheet of material 52 (not shown), or, in a further alternative, on both surfaces (not shown). Alternatively, however, the ultra bright sheet of material 52 may be free of a bonding material. As illustrated in FIG. 3, the bonding material 72, if present, is often disposed on at least a portion of the upper surface 54 of the ultra bright sheet of material 52.

The bonding material 72 may be disposed in a strip of bonding material, although the bonding material 72 also could be applied to a surface of the ultra bright sheet of material 52 in the form of spaced apart spots or the bonding material 72 may also be disposed on one or more surfaces of the ultra bright sheet of material 52 in any geometric shape, non-geometric and/or asymmetric shape, or any combination thereof, including any pattern or plurality of patterns. Further, the bonding material 72 may form at least a part, or, alternatively, all of a decorative pattern or designs on the ultra bright sheet of material 72. In this instance, the bonding material 72 may comprises one or more colors; the bonding material 72 may comprises one or more patterns, and could form a portion or all of a decorative pattern or design. One such bonding material is described in U.S. Pat. No. 5,347,789, entitled, “Decorative Material Having A Colored Sticky Element Disposed Thereon Forming At Least A Portion Of A Decoration And Method”, issued to Donald E. Weder, on Sep. 20, 1994 which is hereby incorporated herein by reference.

The bonding material 72 used to laminate the first sheet of material 12 and the second sheet of material 14 together may also be tinted or colored by using a dye, pigment, or ink. In this manner, different coloring effects are provided, and the first sheet of material 12 and/or the second sheet of material 14 may be given a colored appearance by use of a colored bonding material 72. U.S. Pat. No. 5,147,706 described above provides one water based ink which may be used to tint either first and/or second sheets of material 12 and 14 or which may be used to tint the bonding material 72.

One method for disposing a bonding material, in this case an adhesive, on a sheet of material is described in U.S. Pat. No. 5,111,637 entitled “Method For Wrapping A Floral Grouping” issued to Weder et al., on May 12, 1992, and U.S. Pat. No. 5,111,638, entitled “Method For Wrapping An Object With A Material Having Pressure Sensitive Adhesive Thereon”, issued to D. Weder, May 12, 1992, both of which are hereby incorporated herein by reference. Another method for disposing a bonding material in order to laminate two sheets of material is described in U.S. Pat. No. 4,297,811 entitled “Laminated Printed Foil Flower Pot Wrap With Multicolor Appearance, issued to Weder on Nov. 3, 1981, which is hereby incorporated herein by reference.

The term “bonding material” when used herein means an adhesive, possibly a pressure sensitive adhesive, or a cohesive. Where the bonding material is a cohesive, a similar cohesive material must be placed on the adjacent surface for bondingly contacting and bondingly engaging with the cohesive material. The term “bonding material” also includes materials which are heat sealable and, in this instance, the adjacent portions of the material must be brought into contact and then heat must be applied to effect the seal. The term “bonding material” when used herein also means a lacquer, which may be applied to the sheet of material and, in this instance, heat, sound waves, or vibrations also must be applied to effect the sealing of the lacquer.

The term “bonding material” when used herein also means any type of material or thing which can be used to effect the bonding or connecting of the two adjacent portions of the material or sheets of material to effect the connection or bonding described herein. The term “bonding material” also includes ties, labels, bands, ribbons, strings, tape, staples or combinations thereof. Some of the bonding materials would secure the ends of the sheet of material while other bonding material may bind the circumference of a floral wrapper, a sleeve for a floral grouping or a pot, a preformed flower pot cover and/or a plant cover. Another way to secure the wrapping is to heat seal a portion of the material to another portion of the material. One way to do this is to contact the ends with an iron of sufficient heat to heat seal the material.

The term “bonding material” when used herein also means any heat or chemically shrinkable material, and static electrical or other electrical means, magnetic means, mechanical or barb-type fastening means or clamps, cling-type characteristics of polyethylene or curl-type characteristics of the film or materials incorporated in the sheet of material which can cause the material to take on certain shapes, and any type of welding method which may weld portions of the sheet to itself, to a pot or container, or to both.

The ultra bright material 10 is utilized to form a floral wrapper, a floral sleeve wrapper, a pot wrapper, a preformed flower pot cover, a pot sleeve having a detachable portion which forms a decorative cover, and decorative grass, tinsel, confetti, glitter, and the like. The ultra bright material 10 may also be provided in pads and rolls. All of these embodiments are described in detail below.

### Embodiments and Methods of FIG. 5

Shown in FIG. 5 is a modified ultra bright material 10a which is identical to the ultra bright material 10 shown in FIGS. 3-4 and described in detail previously, except that the ultra bright material 10a is formed into ultra bright sheets of material 52a which are stacked and aligned one on top of the other to form a pad 74 of ultra bright sheets of material 52a.

The pad 74 comprises a top sheet 76 having a next sheet 78 disposed directly thereunder, with additional ultra bright sheets of material 52a disposed under the next sheet 78, all sheets collectively forming the pad 74 of ultra bright sheets of material 52a (one edge of the top sheet 76 lifted for illustration purposes only). The ultra bright sheets of material 52a are generally aligned, and are connected together via a bonding material (not shown), such as, but not by way of limitation, a pressure sensitive adhesive.

When the top sheet 76 of the pad 74 is lifted and removed from the pad 74, the next sheet 78 becomes the new top sheet 76, and the sheet directly below the new top sheet 76 becomes the new next 78. This process is repeated, until all of the ultra bright sheets of material 52a in the pad 74 are removed.

In operation, a floral grouping or flower pot may be placed on the top sheet 76 in the pad 74 and the top sheet 76 may be wrapped about the floral grouping or flower pot and removed from the pad 74. Methods of forming a pad, using the sheets of material to wrap floral groupings, and removing sheets from a pad are described in U.S. Pat. No. 5,181,363 entitled “Wrapping A Floral Grouping With Sheets Having Adhesive Or Cohesive Material Applied Thereto” issued to Weder on Jan. 26, 1993, which is hereby incorporated by reference herein.

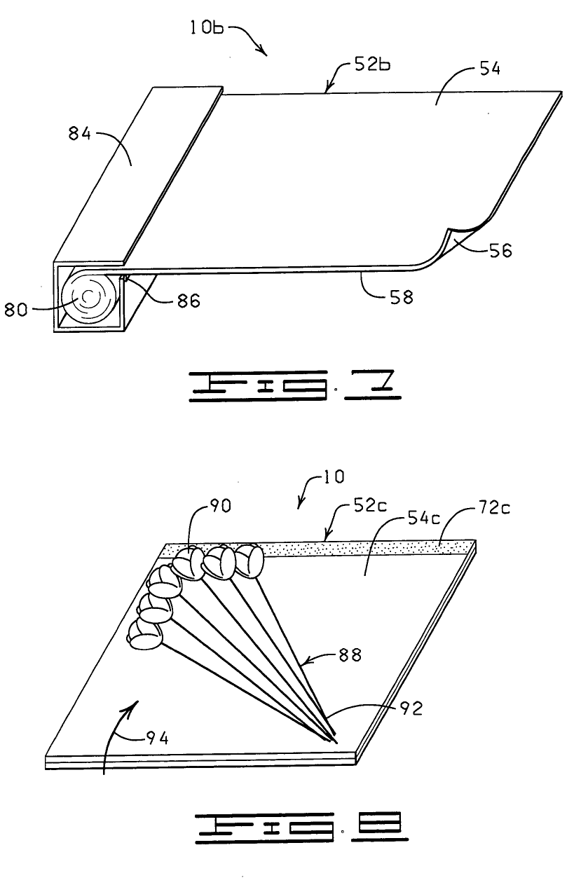

### Embodiments and Methods of FIGS. 6-7

Referring now to FIG. 6, a plurality of individual ultra bright sheets of material 52b are connected linearly together to form a roll 80. Preferably, the plurality of ultra bright sheets of material 52a in the roll 80 are connected by perforations 82, as illustrated in FIG. 6. Such a roll 80 permits one ultra bright sheet of material 52a to be withdrawn from the roll 80, then severed or disconnected from the roll 80. Alternatively, the roll 80 may simply be formed as a continuous roll 80 of ultra bright material without perforations (not shown), wherein a plurality of ultra bright sheets of material 52a may be removed from the roll 80 by unrolling a portion of the roll 80, and using a separate cutting element (not shown) to sever the unrolled portion of the roll 80 of material to form a single ultra bright sheet of material 52b.

The roll 80 may also be contained within a dispenser 84, as illustrated in FIG. 7. When the roll 80 is disposed in the dispenser 84, a portion of the ultra bright material 10b is again unrolled, and a serrated cutting edge 86 contained within the dispenser 80, or a separate cutting element (not shown), severs the unrolled portion of the ultra bright material from the roll 80 to again form a single ultra bright sheet of material 52b. One, or any number of ultra bright sheets of 52b may form a roll 80 as long as it is possible to withdraw at least one ultra bright sheet of material 52b from the roll 80 as described herein.

### Embodiments and Methods of FIGS. 8-11

The ultra bright material 10 may be used to wrap a floral grouping, and shown in FIGS. 8-11 is an ultra bright sheet of material 52c, which is identical to the ultra bright material 10 and the ultra bright sheet of material 52, except that the ultra bright sheet of material 52c is utilized to wrap a floral grouping.

“Floral grouping” as used herein means cut fresh flowers, artificial flowers, a single flower other fresh and/or artificial plants or other floral materials and may include other secondary plants and/or ornamentation or artificial or natural materials which add to the aesthetics of the overall floral grouping, or floral arrangement. The floral grouping 88 comprises a bloom (or foliage) portion 90 and a stem portion 92. It will be appreciated, however, that the floral grouping 88 may consist of only a single bloom or only foliage (not shown). The term “floral grouping” may be used interchangeably herein with the term “floral arrangement”.

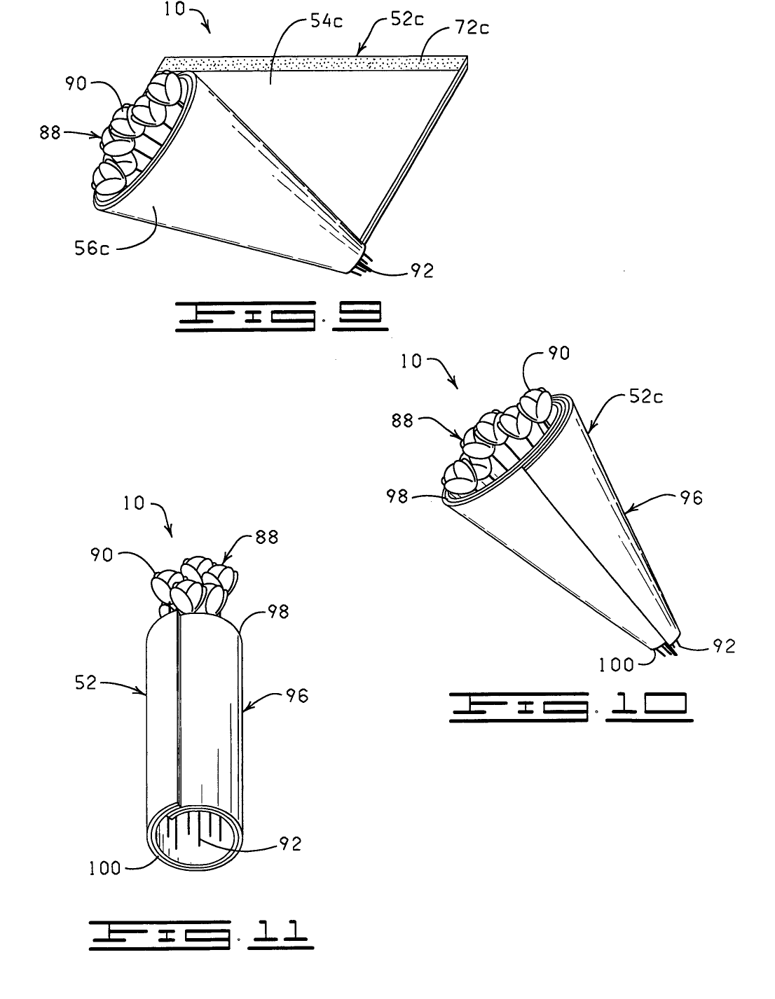

In a method of use, an ultra bright sheet of material 52c is provided. A floral grouping 88 is also provided. The floral grouping 88 having a stem portion 92 and a bloom portion 90 (FIG. 8) is disposed on the upper surface 54c of the ultra bright sheet of 52c. The ultra bright sheet of material 52c then is wrapped about the floral grouping 88 by, in this instance, but not by way of limitation, lifting at least one side, in this instance, the second side 62 of the ultra bright sheet of material 52c and overlapping the lifted portion of the ultra bright sheet of material 52c over the floral grouping 88. The ultra bright sheet of material 52c may be rolled in a rolling direction 94 (FIG. 9) so that the ultra bright sheet of material 52c substantially surrounds at least a portion of the floral grouping 88. At least a portion of the bonding material 72c is disposed adjacent a portion of the lower surface 56d of the ultra bright sheet of material 52c and brought into bonding contact and bonding engagement therewith (FIG. 10) thereby bondingly connecting the upper surface 54c of the ultra bright sheet of material 52c to at least a portion of the lower surface 56c of the ultra bright sheet of material 52c for cooperating to secure the ultra bright sheet of material 52c in a wrapped condition about the floral grouping 88, thereby forming a floral wrapper 96, as illustrated in FIG. 10.

In the wrapped condition with the ultra bright sheet of material 52c wrapped about the floral grouping 88 as shown in FIG. 10, the floral wrapper 96 forms a conical shape with an opened upper end 98 and an opened lower end 100. The floral wrapper 96 usually covers at least a portion of the bloom portion 90 of the floral grouping 88. A portion of the stem portion 92 of the floral grouping 88 extends through the opened lower end 100 of the floral wrapper 96. The floral wrapper 96 is often tightly wrapped about the stem portion 92 of the floral grouping 88.

In some applications, the stem portion 92 of the floral grouping 88 extends through the open lower end 100 of the floral wrapper 96, as described before. In other applications, the stem portion 92 does not extend through the open lower end 100 of the floral wrapper 96. It will be appreciated that in some applications, the floral wrapper 96 has a closed lower end (not shown), or alternatively, the lower end may be closed optionally. Similarly, it will be understood that in some applications, the floral wrapper may have a closed upper end as well (not shown), or alternatively, the upper end may be closed optionally.

In some applications, the floral wrapper 96 is tightly wrapped about the stem portion 92 of the floral grouping 96 (not shown). In other applications, however, the floral wrapper 96 may be crimped about the stem portion 98 of the floral grouping 88 (not shown). Crimping is discussed in detail below. The bloom portion 90 of the floral grouping 88 is disposed near the open upper end 98 of the floral wrapper 96 and the bloom portion 90 of the floral grouping 88 is visible via the open upper end 98 of the floral wrapper 96. The bloom portion 90 may, in some instances, extend beyond the open upper end 98 of the floral wrapper 96.

The floral wrapper 96 shown in FIG. 10 is conically shaped. It will be appreciated, however, that the ultra bright sheet of material 52c may also be wrapped about the floral grouping 88 to form a cylindrically shaped floral wrapper 96′ as shown in FIG. 11. It will also be understood that other shapes of floral wrappers 96 may be achieved with differing wrapping techniques, including geometric shapes, non-geometric shapes, asymmetric shapes and/or any combination thereof. Specifically, U.S. Pat. No. 5,181,364, entitled “Wrapping A Floral Grouping With Sheets Having An Adhesive Or Cohesive Material Applied Thereto”, issued to Weder et al. on Jan. 26, 1993, which is hereby incorporated by reference herein, discloses methods and techniques of wrapping a floral grouping in a cylindrically-shaped wrapper.

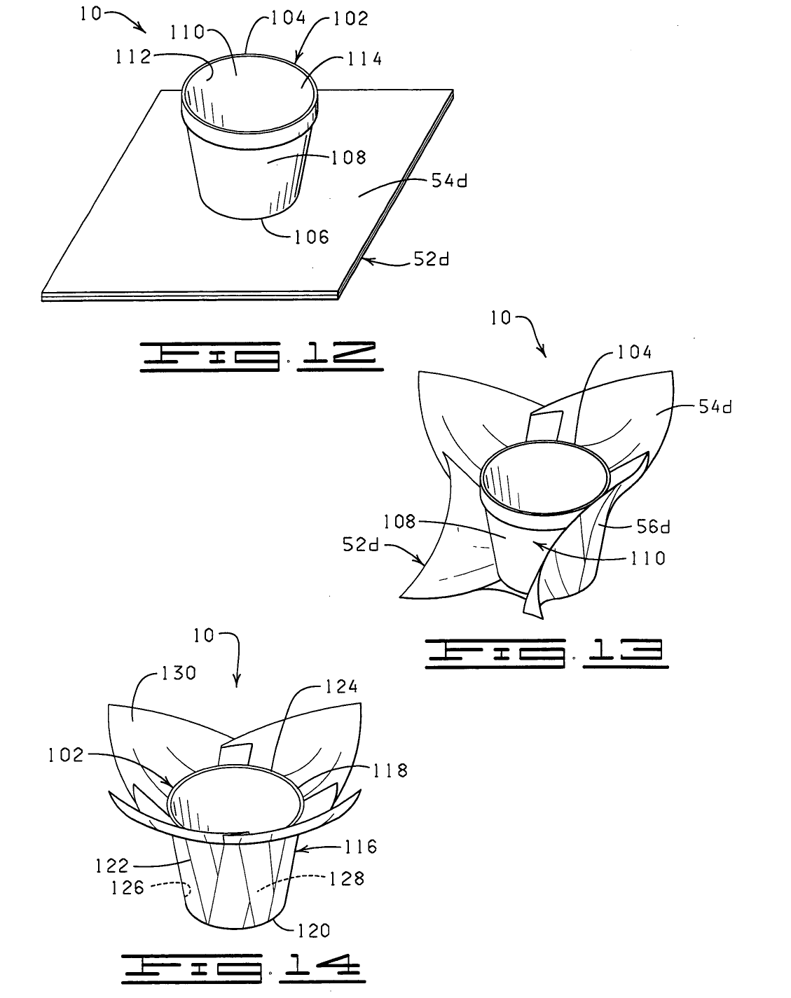

### Embodiments and Methods of FIGS. 12-14

As noted previously, the ultra bright material 10 may be used to wrap an object such as a flower pot, or to provide a cover for a plant or floral grouping contained in a growing medium, and shown in FIGS. 12-14 is an ultra bright sheet of material 52d, which is identical to the ultra bright material 10 and the ultra bright sheet of material 52, except that the ultra bright sheet of material 52d is utilized to wrap a flower pot.

The term “flower pot” refers to any type of container used for holding a floral grouping or a potted plant. Examples of flower pots used in accordance with the present invention are glass pots, clay pots, plastic pots, styrofoam pots, wooden pots, pots made from natural and/or synthetic fiber, and the like.

The flower pot 102 has an open upper end 104, a lower end 106 and an outer surface 108. An opening 110 intersects the open upper end 102 forming an inner surface 112 and a retaining space 114.

A modified ultra bright sheet of material 52d, identical to the ultra bright sheet of material 52 shown in FIGS. 3-4 is provided, as shown in FIG. 12. To cover the flower pot 102, the ultra bright sheet of material 52d may be manually or automatically formed about the outer surface 108 of the flower pot 102, or, alternatively, about a growing medium containing a plant (not shown). Alternatively, however, the ultra bright sheet of material 52d may be formed into a preformed flower pot cover which is then placed about the outer surface 108 of the pot 102, or about the growing medium having a plant growing therefrom. These alternative are discussed in further detail later herein.

In a method of use, referring to FIGS. 12-14, to form an ultra bright sheet of material 52d into a decorative pot wrapper 116, both a flower pot 102 and an ultra bright sheet of material 52d are provided. The pot 102 is disposed upon the upper surface 54d of the ultra bright sheet of material 52d, so the lower end 106 of the pot 102 rests upon a portion of the upper surface 54d of the ultra bright sheet of material 52d.

In one embodiment of a manual application of the ultra bright sheet of material 52d about the pot 102, the upper surface 54d of the ultra bright sheet of material 52d is formed about the outer surface 108 of the pot 102 (FIG. 13), thereby engaging the outer surface 108 of the pot 102 to form a decorative pot wrapper 116, as shown in FIG. 14, in a manner which is known to those having ordinary skill in the art. One method for wrapping a sheet of material about a pot for forming such a decorative cover 116 is shown in U.S. Pat. No. 4,733,521 entitled “Cover Forming Apparatus” issued to Weder et al., on Mar. 29, 1988, which is hereby incorporated herein by reference.

The pot wrapper 116 has an upper end 118, a lower end 120 and an outer surface 122. An opening 124 intersects the upper end 118 forming an inner surface 126 and a retaining space 128. A skirt 130 may be formed adjacent the upper end 118. Alternatively, however, the pot wrapper 116 may be formed without a skirt (not shown).

A decorative pot wrapper 116 may also be formed by wrapping the ultra bright sheet of material 52d about a pot 102 as described previously, and securing the ultra bright sheet of material 52d to the pot 102 by the use of one or more bonding materials described herein. One particular method of securing the a decorative pot wrapper 116 to the pot 102 is by applying a band (not shown) about the pot to hold the decorative pot wrapper 116 in place about the pot, such as is described in U.S. Pat. No. 5,115,599 entitled “Means For Securing A Decorative Cover About A Flower Pot” issued to Weder on Apr. 21, 1992, which is hereby incorporated herein by reference.

The term “band” when used herein means any material which may be secured about an object such as a flower pot, such bands commonly being referred to as elastic bands, rubber bands or nonelastic bands and also includes any other type of material such as an elastic or non-elastic string or elastic piece of material, nonelastic piece of material, a round piece of material, a flat piece of material, a ribbon, a piece of paper strip, a piece of plastic strip, a piece of wire, a tie wrap or a twist tie or combinations thereof or any other device capable of gathering the sheet of material to removably or substantially permanently form a crimped portion and secure the crimped portion formed in the sheet of material which may be secured about an object such as the flower pot. The band also may include a bow if desired in a particular application.

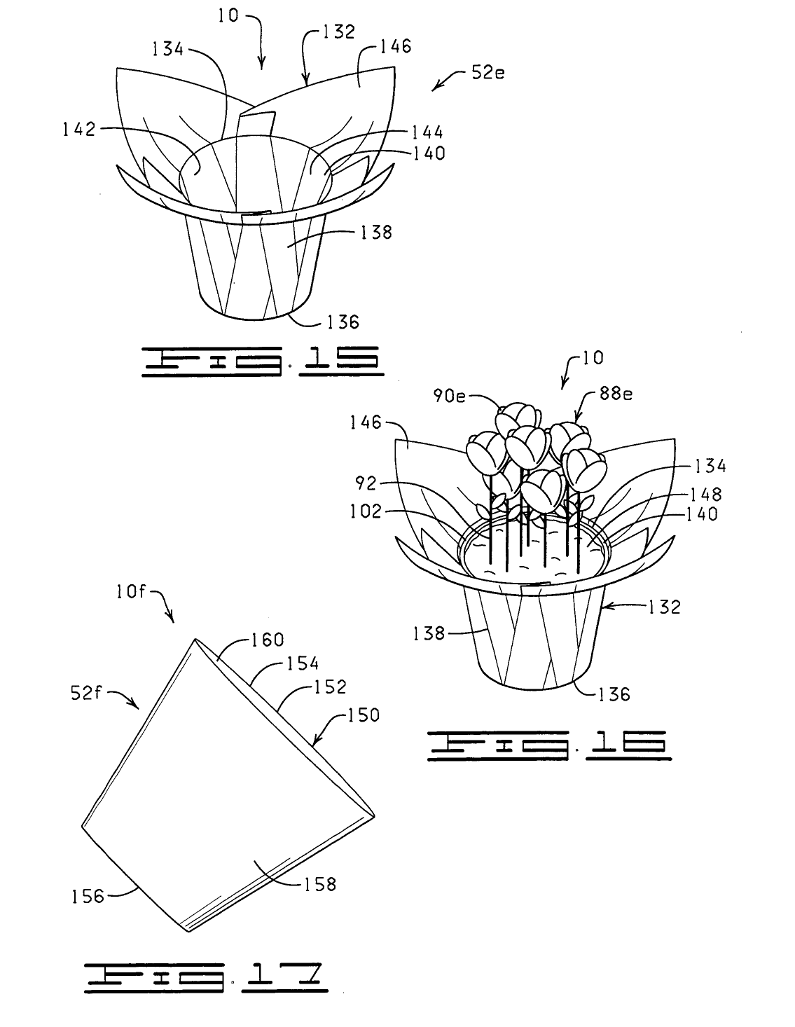

### Embodiments and Methods of FIGS. 15-16

As noted previously, the ultra bright material 10 may be formed into a preformed flower pot cover or plant cover, for decoratively covering a flower pot, or to provide a cover for a plant contained in a growing medium. The term “growing medium“when used herein means any liquid, solid or gaseous material used for plant growth or for the cultivation of propagules, including organic and inorganic materials such as soil, humus, perlite, vermiculite, sand, water, and including the nutrients, fertilizers or hormones or combinations thereof required by the plants or propagules for growth.

Illustrated in FIGS. 15-16 is an ultra bright sheet of material 52e, which is identical to the ultra bright material 10 and the ultra bright sheet of material 52, except that the ultra bright sheet of material 52e is formed into a pre-formed flower pot cover 132.

The preformed flower pot cover 132 has an upper end 134, a lower end 136 and an outer surface 138. The upper end 134 is intersected by an opening 140 forming an inner surface 142 and a pot retaining space 144. A skirt 146 may be formed adjacent the upper end 134, as shown in FIG. 15. Alternatively, however, the preformed flower pot cover 132 may be formed without a skirt (not shown).

The decorative preformed flower pot cover 132 is self-supporting by virtue of overlapping folds, which provide a rigid but flexible structure for the preformed flower pot cover 132. In some alternative embodiments, the structure and shape of the preformed flower pot cover 132 may be maintained by a bonding material which holds the overlapping folds in place, thereby holding the structure of the preformed flower pot cover 132 in place. In other embodiments, the shape-sustaining characteristics of the ultra bright sheet of material 52e are sufficient to both form and hold the rigid yet flexible structural shape of the preformed flower pot cover 132, but still provide flexibility for the preformed flower pot cover 132.

A flower pot 102 having a floral grouping 88e disposed in a growing medium 148 may be disposed into the opening 140 of the preformed flower pot cover 132, thereby resulting in a decoratively covered pot 102, as illustrated in FIG. 16. One method for forming such a preformed plant cover or pot cover is shown in U. S. Pat. No. 4,773,182 entitled “Article Forming System” issued to Weder et al., on Sep. 27, 1988, which is hereby incorporated herein by reference.

### The Embodiments and Methods of FIGS. 17-20

Shown in FIGS. 17-20 and designated therein by the general reference numeral 150 is a floral sleeve wrapper for a floral grouping 88f constructed from at least one ultra bright sheet of material 52f, as shown in FIGS. 3-4 and described in detail herein previously. The floral sleeve wrapper 150 comprises a sleeve 152 which may be formed from a single web and/or a single sheet of material, which may be formed from two sheets of material which are aligned and connected together, or which may be formed from multiple sheets of material which are connected together to form the sleeve 152. The floral sleeve wrapper 150 is often tubular or frusto-conical in shape, although it will be appreciated that any shape may be utilized, so long as the floral sleeve wrapper 150 operates in the manner shown and described herein. The floral sleeve wrapper 150 comprises both a floral grouping 88f and a sleeve 152.

The sleeve 152 has an upper end 154, a lower end 156 and an outer surface 158. An opening 160 intersects both the upper end 154 and the lower end 156 forming an inner surface 162 and a floral retaining space 164. In some embodiments (not shown), the lower end 156 is closed, or is formed as a closed lower end (not shown).

In some embodiments, the upper end 154 is closed after a floral grouping is disposed therein (not shown).

Sleeves, and their construction, are well known in the art and sleeves are commercially available, as are various devices and mechanisms capable of forming sleeves. One example of such sleeves is found in U.S. Pat. No. 5,497,881, entitled, “Floral Grouping Wrapper And Methods”, issued to D. Weder Mar. 12, 1996. In a frequent manner of construction, a first sheet of material and a second sheet of material will be sealed together to form the sleeve 152, with the a substantial portion of the first sheet of material laying adjacent the second sheet of material, and the sleeve 152 being naturally retained in a flattened and unopened state until opened by an operator and held in an opened position, the opened position forming the floral retaining space 164, so that a floral grouping 88f may be both received within and retained in the floral retaining space.

The floral sleeve wrapper 150 comprises both the sleeve 152 and the floral grouping 88f (FIGS. 19-20). The sleeve 152, when opened and held in an opened position, is adapted to receive the floral grouping 88f within the floral retaining space 164.

The floral grouping 88f (FIGS. 19-20) is disposed in the opening 160 of the sleeve 152 and contained substantially in the floral retaining space 164 of the sleeve 152, as will be described in detail below.

A bonding material (not shown) may be disposed on at least a portion of the inner surface 162 of the sleeve 152, or, alternatively, the bonding material may be disposed on the outer surface 158 of the sleeve 152 (not shown). A bonding material may be disposed on both the inner surface 162 and the outer surface 158 of the sleeve 152 (not shown). Further, it will be appreciated that the sleeve 152 may be free of a bonding material.

In a general method of use, illustrated in FIGS. 17-20, at least a portion of the floral grouping 88f is disposed within the sleeve 152 (FIG. 19). In some applications, the stem portion 92f of the floral grouping 88f extends into the sleeve 152 via the opening 160 in the upper end 154, the stem portion 92f extending through the open lower end 156 of the sleeve 152. The bloom portion 90f of the floral grouping 88f is therefore disposed near the upper end 154 of the sleeve 152 and the bloom portion 90f of the floral grouping 88f is often visible via the upper end 154 of the sleeve 152 (FIGS. 19-20). In some instances, the bloom portion 90f of the floral grouping 88f may extend above the upper end 154 of the sleeve 152, in other instances, the bloom portion 90f may extend below the upper end 154 of the sleeve 152 (not shown).

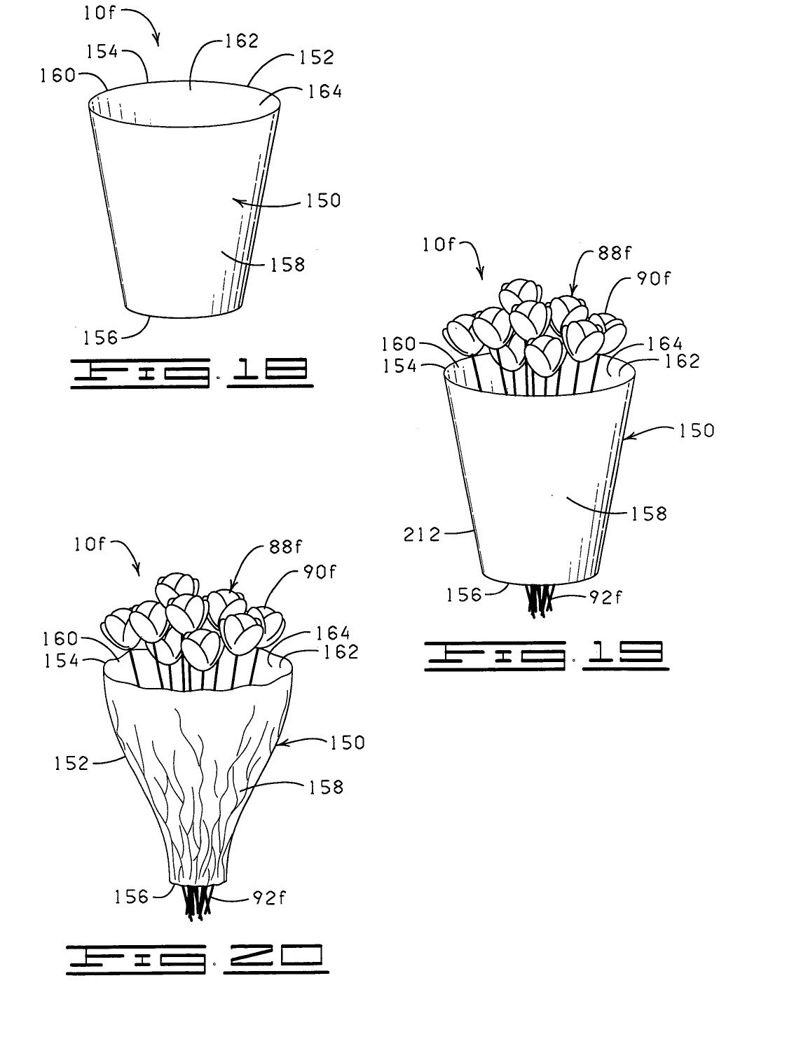

In one method of use (FIGS. 17-20), an operator provides a flattened sleeve 152 (FIG. 17) and a floral grouping 88f. The operator then opens the sleeve 152 (FIG. 18) at the upper end 154 and holds the sleeve 152 in an opened position, thereby expanding outward and widening the floral retaining space 164 such that the floral retaining space 164, when the sleeve 152 is in an opened position, is sized to both receive and retain a floral grouping 88f therein. The operator disposes the floral grouping 88f into the opened sleeve 152 via the opening 160 in the upper end 154 and assuring that the floral retaining space 164 is widened and expanded outward, proceeds to insert the stem portion into and, often, through the lower end 154 of the opened sleeve 152, the lower end 156 of the sleeve 152 frequently having the narrowest diameter (FIG. 19). In inserting the floral grouping 88f into the sleeve 152 in this manner, the bloom portion 90f is also disposed in the floral retaining space 164 of the sleeve 152 and the bloom portion 90f is disposed close to and/or adjacent the upper end 154 of the sleeve 152, the upper end 154 frequently having the widest diameter (FIGS. 19-20). In this manner, the floral sleeve wrapper 150 having both a floral grouping 88f and a sleeve 152 is created.

The sleeve 152 may be crimped about the floral grouping 88f, as shown in FIG. 20. The crimping is conducted by an operator after the floral grouping 88f is disposed in the sleeve 152 by gathering and crimping at least a portion of the sleeve 152 about the floral grouping 88f, often in the area of the stem portion 92f of the floral grouping 152. Such crimping may be conducted by hand, by grasping and substantially encompassing with one or more hands the lower end 156 of the sleeve 152 in the area if the stem portion 92f and evenly and firmly squeezing that portion of the sleeve 152 about the area of the stem portion 92f, thereby pressing and gathering the sleeve 152 against itself and about the stem portion 92f of the floral grouping 88f. It will be appreciated that if the sleeve 152 is crimped in an area having bonding material (not shown), the bonding material will assist in holding the crimped area in a crimped position.

The sleeve 152 may also be crimped by using both a crimping motion (as described above) and a turning motion to create a twisted crimping, resulting in a sleeve 152 which is both crimped as previously described, and which is twisted about at least a portion of the stem portion 92f of the floral grouping 88f, the sleeve 152 near the stem portion 90f being rotated for example, but not by way of limitation, about the stem portion 92f between about one-eighth of a turn to about a full turn (not shown). Crimping floral wrappers and floral sleeve wrappers about floral groupings is shown and described in U.S. Pat. No. 5,428,939, entitled “Method For Crimping A Wrapper About A Floral Grouping”, issued Jul. 4, 1995 to Weder et al., which is hereby incorporated by reference herein. It will be further understood that any embodiment herein may be subject to crimping.

Alternatively, the sleeve 152 may remain uncrimped. The bonding material, when disposed upon the sleeve 152, may cause the sleeve 152 to bondingly connect to portions of itself, causing the sleeve 152 to conform, either generally, or closely (depending, as will be appreciated, upon the amount of bonding material and the amount of the ultra bright material 10f of the sleeve 152 which overlaps and connects to itself) to the floral grouping 88f.

When the floral grouping 88f is disposed in the sleeve 152 by any method shown and/or described herein, or known in the art, the sleeve 152 substantially surrounds and encompasses a substantial portion of the floral grouping 88f. It will be appreciated that the sleeve 152 has sufficient flexibility but also sufficient rigidity to both remain in and sustain its general shape, thereby substantially surrounding and encompassing the floral grouping 88f.

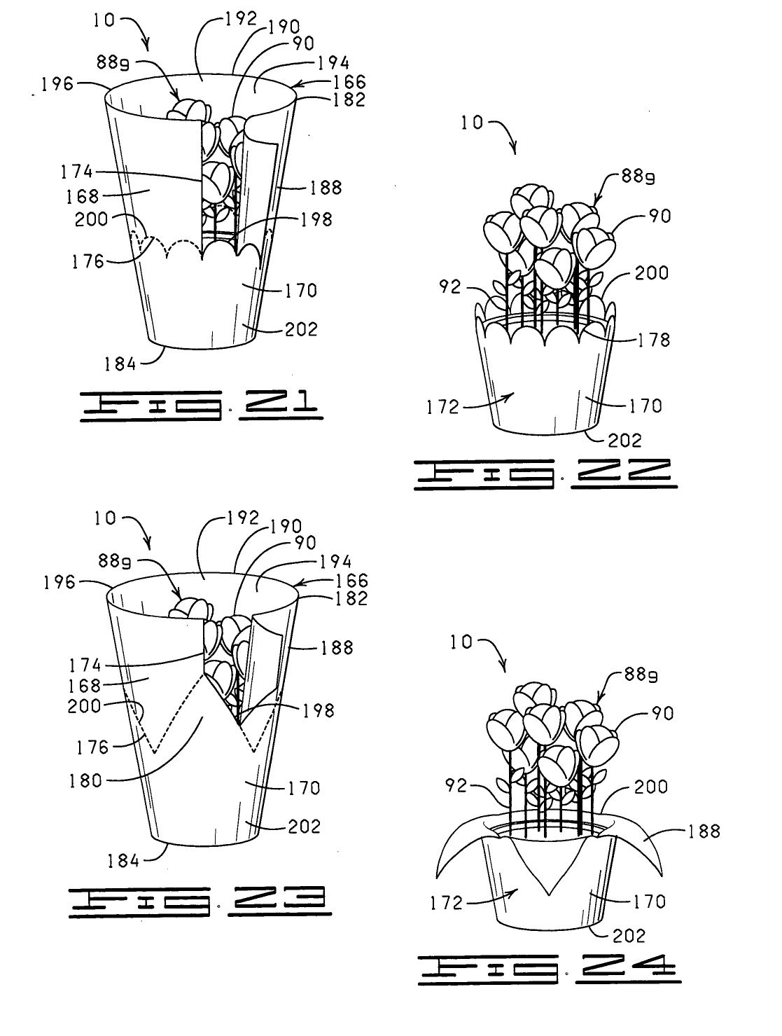

### The Embodiments and Methods of FIGS. 21-24

As illustrated in FIGS. 21-24, a pot sleeve 166 may also be provided, to dispose over a pot 102g alone, or most frequently, over a pot (not shown) having a floral grouping 88g disposed therein. The pot sleeve 166 is formed by any means or method shown and/or described herein, or known in the art. It will be understood that the pot sleeve 166 is substantially flat until opened to receive a flower pot 102g.

Pot sleeves have been used to cover pots and containers. Some such pot sleeves are disclosed in U.S. Pat. No. 5,572,851, entitled, “Plant Package Having A Detachable Sleeve And Methods”, issued to D. Weder Nov. 12, 1996, and U.S. Pat. No. 5,625,979, entitled, “Sleeve Having A Detachable Portion Forming A Skirt And Methods”, issued to D. Weder May 6, 1997, both of which are hereby incorporated by reference herein.

The pot sleeve 166 has an upper sleeve portion 168 and a lower portion 170, the lower portion 170 forming a decorative cover 172 when the upper sleeve portion 168 is removed therefrom. Vertical perforations 174 are disposed in the upper sleeve portion 168, and non-linear circumferential perforations 176 are utilized to separate the upper sleeve portion 168 from the lower portion 170. The lower portion 170 may have a non-linear decorative edge 178 when the upper sleeve portion 168 is removed therefrom. Alternatively, however, the lower portion may have a skirt 180 formed integrally therewith when the upper sleeve portion 168 is removed therefrom.

It will be appreciated that when the pot sleeve 166 is disposed on the pot 102f, the pot sleeve 166 extends substantially over the outer surface 108g of a flower pot 102g. Alternatively, however, the pot sleeve 166 may extend over a pot 102g already covered by a preformed flower pot cover or pot wrapper, the pot sleeve 166 often being torn away from the preformed flower pot cover or pot wrapper after shipment and delivery (not shown).

The pot sleeve 166 may have a bonding material disposed thereon such that a portion of the pot sleeve 166 will connect to the pot 102g, or any decorative cover covering the pot 102g (not shown). Alternatively, a bonding material may be disposed upon the outer surface 108g of the flower pot 102g (not shown). In a further alternative, a bonding material may be disposed on both the pot 102g and the pot sleeve 166 (not shown).

The pot sleeve has an upper end 182, a lower end 184 and an outer surface 188. An opening 190 intersects the upper end 182 and, often, the lower end 184 as well, forming an inner surface 192 and a retaining space 194. The upper sleeve portion 168 has an upper end 196 and a lower end 198, the lower end 198 being defined by the non-linear circumferential perforations 176. The lower portion 170 also has an upper end 200 which begins at the nonlinear circumferential perforations 176 and a lower end 202. The upper sleeve portion 168 is removed via the vertical perforations and the non-linear circumferential perforations, as illustrated in FIGS. 21-22. When the upper sleeve portion 168 is completely removed from the lower portion 170, the lower portion 170 is left with a non-linear decorative edge 178, and forms the decorative cover 172 about the pot 102g, as shown in FIG. 22.

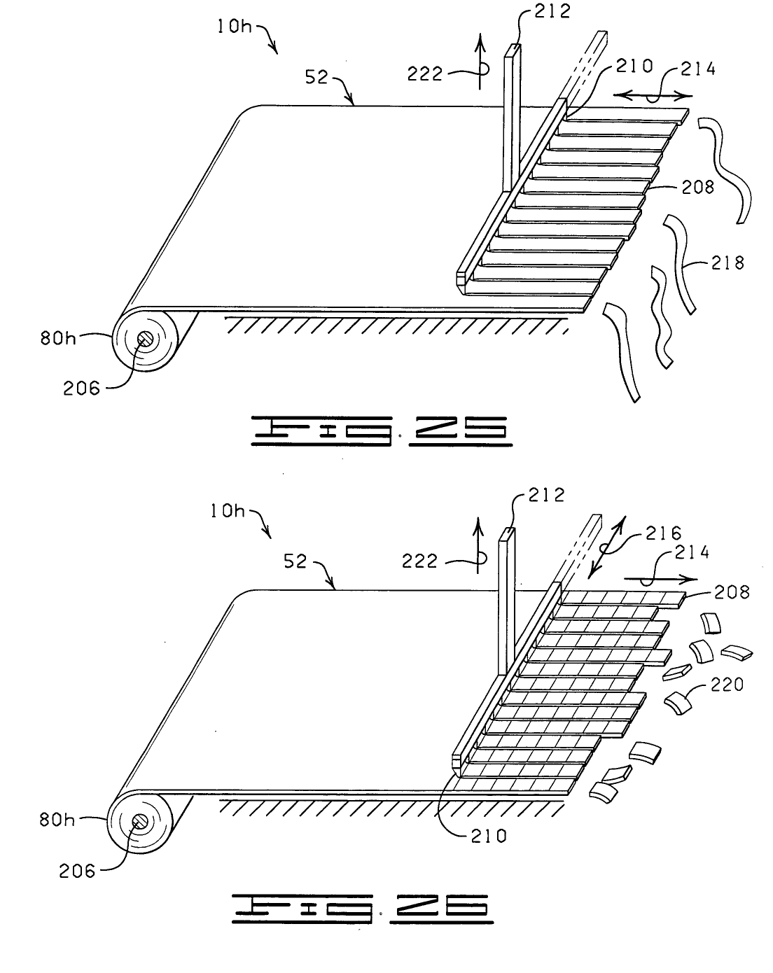

In an alternative embodiment, illustrated in FIGS. 2324, the non-linear circumferential perforations 176 are formed in the pot sleeve 166 such that, when the upper sleeve portion 168 is removed, the lower portion is left with a skirt 180 connected thereto, the skirt 180 extending a distance from the upper end 200 of the lower portion 170, thereby forming a decorative cover 172 having a skirt 180 (FIG. 24).

It will be appreciated that the method of disposing a flower pot 102g into the pot sleeve 166 is generally substantially similar to the method described above for disposing a floral grouping 88f into a sleeve 152. It will be understood that the flattened pot sleeve 166 will be opened by an operator and held in an opened position, thereby opening the retaining space 194 a sufficient amount to receive a pot 102g, the pot 102g often having a floral grouping 88g disposed therein, inserted into and retained in the retaining space 194 of the pot sleeve 166.

When the pot 102g or a pot 102g having a floral grouping 88g disposed therein is inserted into the pot sleeve 166 by any method shown and/or described herein, or known in the art, the upper sleeve portion 168 of the pot sleeve 166 substantially surrounds and encompasses a substantial portion of the floral grouping 88g. When the upper sleeve portion 168 is removed, it will be understood that the lower portion 170 substantially surrounds the pot 102g. It will be appreciated that the pot sleeve 166 has sufficient flexibility but also sufficient rigidity to both remain in and sustain its general shape.

### The Embodiments and Methods of FIGS. 25-26

Shown in FIGS. 25-26 is a modified roll 80h of ultra bright material 10. The roll 80h of ultra bright material 10h is constructed exactly like the roll 80 of ultra bright material 10 described previously, except the roll 80i of ultra bright material 10h is not disposed in a dispenser constructed like the dispenser 84 shown in FIG. 7. Rather, the roll 80h of ultra bright material 10h is supported on a generally mounted shaft 206. A portion of the ultra bright material 10h is withdrawn from the roll 80h via a leading edge 208 until a predetermined length of the ultra bright material 10h has been withdrawn from the roll 80h. In this position, a portion of the ultra bright material 10h is disposed under a plurality of knife edges 210 (only one of the plurality of knife edges being designated by the numeral 210). The plurality of knife edges 210 is connected to an actuator 212 adapted to move the plurality of knife edges 210 in a first shredding direction 214 and in a second cutting direction 216. When the predetermined length of the ultra bright material 10h has been withdrawn from the roll 80h, the actuator 212 actuates to move the plurality of knife edges 210 in the first shredding direction 214 to a position wherein the plurality of knife edges 210 severingly engages the ultra bright material 10h to shreddingly cut a plurality of elongated portions of the ultra bright material 10h from the roll 80h. An operator may then turn the plurality of knife edges 210 a second direction 216, or, alternatively, actuate another cutting element (not shown), to sever the plurality of elongated portions 218 of the ultra bright material 10h from the roll 80h. In this manner, but not by way of limitation, the plurality of elongated portions 218 cut from the ultra bright material 10h forms decorative grasses, tinsel, confetti, and the like.

In another optional mode, an operator may again operate the actuator 212 such that the plurality of knife edges 210 are turned the second cutting direction 216 wherein the plurality of knife edges 210 severingly re-engages the plurality of elongated portion 218 having short lengths, as illustrated in FIG. 26, thereby causing the plurality of elongated portions 218 to be severed into small pieces 220, for use as, but not by way of limitation, glitter, confetti, and the like. Alternatively, the leading edge 208 may be run across a first plurality of knife edges (not shown) set in a surface to form the plurality of elongated portions 218, wherein the actuator 212 actuates a second knife edge (not shown) to cross-cut the plurality of elongated portions into small pieces 220.

The actuator 212 may comprise a hydraulic or pneumatic cylinder or a motor and gear arrangement or any other form of arrangement suitable for moving the plurality of knife edges 210 in the first shredding direction 214 and the second cutting direction 216. After the plurality of knife edges 210 has cuttingly severed the ultra bright material 10h into the desired shapes and sizes, the actuator 212 is usually actuated to move the plurality of knife edges 210 in a storage direction 222 to a storage position (not shown) disposed a distance above the ultra bright material 10h. Apparatus and methods for making decorative shredded materials and the like are disclosed in U.S. Pat. No. 4,646,388, entitled, “Apparatus For Producing Weighed Charges Of Loosely Aggregated Filamentary Material”, issued to Weder et al. on Mar. 3, 1987, which is hereby incorporated by reference herein.

Changes may be made in the embodiments of the invention described herein, or in parts or elements of the embodiments described herein, or in the sequence of steps of the methods described herein, without departing from the spirit and/or scope of the invention as defined in the following claims.

What is claimed is:

1. A substantially shape sustaining ultra bright material having a first surface and a second surface wherein the first surface has a greater reflectivity than the second surface thereof, the ultra bright material comprising:
a metal foil having a first surface and a second surface, the first surface having a greater reflectivity than the second surface; and
a metallized film having a substantial reflectivity, the metallized film disposed adjacent the first surface of the metal foil and connected thereto, thereby forming the ultra bright material.

2. The ultra bright material of claim 1 wherein the ultra bright material further comprises a bonding material.

3. The ultra bright material of claim 2 wherein the bonding material comprises an adhesive bonding material.

4. The ultra bright material of claim 2 wherein the bonding material comprises a cohesive bonding material.

5. The ultra bright material of claim 1 wherein the ultra bright material further comprises characteristics selected from the group consisting of decorations, colorings, coatings, embossings, flockings, metallic finishes, pearlescent finishes, translucent finishes, transparent finishes, iridescent finishes, neon finishes, holographic finishes, holographic designs, opaque finishes, clear finishes, and any combination thereof.

6. The ultra bright material of claim 1 wherein the ultra bright material is constructed from a sheet of material having a thickness in a range of about 0.1 mils to about 10 mils.

7. The ultra bright material of claim 1 wherein the ultra bright material is constructed from a sheet of material having a thickness in a range of about 0.4 mils to about 2.0 mils.

8. The ultra bright material of claim 1 wherein the ultra bright material is cut into elongated portions.

9. The ultra bright material of claim 1 wherein the ultra bright material is cut into small pieces.

10. An assembly, comprising:
an item having an outer periphery; and
a substantially shape sustaining ultra bright material having a first surface and a second surface wherein the first surface has a greater reflectivity than the second surface thereof, the ultra bright material comprising
a metal foil having a first surface and a second surface, the first surface having a greater reflectivity than the second surface; and
a metallized film having a substantial reflectivity, the metallized film disposed adjacent the first surface of the metal foil and connected thereto, thereby forming the ultra bright material, wherein the outer periphery of the item is substantially surrounded and encompassed by the ultra bright material, the ultra bright material forming a wrapping about the item.

11. The ultra bright material of claim 10 wherein the ultra bright material further comprises a bonding material.

12. The ultra bright material of claim 11 wherein the bonding material comprises an adhesive bonding material.

13. The ultra bright material of claim 10 wherein the bonding material comprises a cohesive bonding material.

14. The ultra bright material of claim 10 wherein the ultra bright material further comprises characteristics selected from the group consisting of decorations, colorings, coatings, embossings, flockings, metallic finishes, pearlescent finishes, translucent finishes, transparent finishes, iridescent finishes, neon finishes, holographic finishes, holographic designs, opaque finishes, clear finishes, and any combination thereof.

15. The ultra bright material of claim 10 wherein the ultra bright material is constructed from a sheet of material having a thickness in a range of about 0.1 mils to about 10 mils.

16. The ultra bright material of claim 10 wherein the ultra bright material is constructed from a sheet of material having a thickness in a range of about 0.4 mils to about 2.0 mils.

17. The ultra bright material of claim 10 wherein the item is a floral grouping, and the ultra bright material forms a floral wrapper about the floral grouping.

18. The ultra bright material of claim 10 wherein the item is a pot, and the ultra bright material forms a pot wrapper about the pot.

19. The ultra bright material of claim 10 wherein the item is a pot, and the wrapping is further defined as a preformed flower pot cover.

20. The ultra bright material of claim 10 wherein the item is a floral grouping, and the ultra bright material forms a floral sleeve wrapper about the floral grouping.

21. The ultra bright material of claim 10 wherein the item is a pot, and the ultra bright material forms a pot sleeve about the pot, a portion of the pot sleeve being removable, leaving a decorative cover about the pot.

22. A method of forming an ultra bright material, comprising the steps of:
providing a metal foil having a first surface and a second surface, the first surface having a greater reflectivity than the second surface;
providing a metallized film having a substantial reflectivity;
disposing the metallized film adjacent the first surface of the metal foil; and
bondingly connecting the metallized film to the metal foil to provide a substantially shape sustaining ultra bright material, the ultra bright material having a first surface and a second surface, the first surface of the ultra bright material having a greater reflectivity than the second surface.

23. The method of claim 22 wherein in the step of bondingly connecting the metallized film to the metal foil, the ultra bright material is further defined as having a bonding material.

24. The method of claim 22 wherein in the bonding material is further defined as an adhesive bonding material.

25. The method of claim 23 wherein the bonding material is further defined an a cohesive bonding material.

26. The method of claim 22 wherein in the step of bondingly connecting the metallized film to the metal foil, the ultra bright material further comprises characteristics selected from the group consisting of decorations, colorings, coatings, embossings, flockings, metallic finishes, pearlescent finishes, translucent finishes, transparent finishes, iridescent finishes, neon finishes, holographic finishes, holographic designs, opaque finishes, clear finishes, and any combination thereof.

27. The method of claim 22 wherein in the step of bondingly connecting the metallized film to the metal foil, the ultra bright material is further defined as being constructed from a sheet of material having a thickness in a range of about 0.1 mils to about 10 mils.

28. The method of claim 22 wherein in the step of bondingly connecting the metallized film to the metal foil, the ultra bright material is further defined as being constructed from a sheet of material having a thickness in a range of about 0.4 mils to about 2.0 mils.

29. A method for wrapping an item with an ultra bright material, comprising the steps of:
providing an item having an outer periphery; and
providing a substantially shape sustaining ultra bright material having a first surface and a second surface wherein the first surface has a greater reflectivity than the second surface thereof, the ultra bright material comprising a metal foil having a first surface and a second surface, the first surface having a greater reflectivity than the second surface; and
a metallized film having a substantial reflectivity, the metallized film disposed adjacent the first surface of the metal foil and connected thereto, thereby forming the ultra bright material;
positioning at least a portion of the ultra bright material about the outer periphery of the item; and
wrapping at least a portion of the outer periphery of the item with the ultra bright material thereby forming a wrapping about the item.

30. The method of claim 29 wherein in the step of providing an ultra bright material, the ultra bright material further comprises a bonding material.

31. The method of claim 30 wherein the bonding material is further defined as an adhesive bonding material.

32. The method of claim 30 wherein the bonding material is further defined an a cohesive bonding material.

33. The method of claim 29 wherein in the step of providing an ultra bright material, the ultra bright material further comprises characteristics selected from the group consisting of decorations, colorings, coatings, embossings, flockings, metallic finishes, pearlescent finishes, translucent finishes, transparent finishes, iridescent finishes, neon finishes, holographic finishes, holographic designs, opaque finishes, clear finishes, and any combination thereof.

34. The method of claim 29 wherein in the step of providing an ultra bright material, the ultra bright material is further defined as being constructed from a sheet of material having a thickness in a range of about 0.1 mils to about 10 mils.

35. The method of claim 29 wherein in the step of providing an ultra bright material, the ultra bright material is further defined as being constructed from a sheet of material having a thickness in a range of about 0.4 mils to about 2.0 mils.

36. The method of claim 29 wherein in the step of wrapping the item, the item is further defined as a floral grouping, and the wrapping forms a floral wrapper about the floral grouping.

37. The method of claim 29 wherein in the step of wrapping the item, the item is further defined as a pot, and the wrapping forms a pot wrapper about the pot.

38. The method of claim 29 wherein in the step of wrapping the item, the item is further defined as a pot, and the wrapping forms a preformed flower pot cover which is disposed about the pot.

39. The method of claim 29 wherein in the step of wrapping the item, the item is further defined as a floral grouping, and the wrapping forms a floral sleeve wrapper which is disposed about the floral grouping.

40. The method of claim 29 wherein in the step of wrapping the item, the item is defined as a pot, and the wrapping forms a pot sleeve which is disposed about the pot, a portion of the pot sleeve being removable, leaving a decorative cover about the pot.
